(19) United States
(12) Patent Application Publication
(10) Pub. No.: US 2008/0238849 A1
(43) Pub. Date: Oct. 2, 2008

(54) Liquid crystal display device

(75) Inventor: Hideki Kanou, (US)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 12/073,152

(22) Filed: Feb. 29, 2008

(30) Foreign Application Priority Data
Mar. 28, 2007 (JP) 2007-085522

(51) Int. Cl. G09G 3/36

(52) U.S. Cl. 345/88; 345/89

(57) ABSTRACT

An LCD device includes a liquid crystal display panel, a receiver, which receives color image data by frame in series, a generator generating gray image data, which are displayable at the liquid crystal display panel, a selector inserting the gray image data as a frame image between two frames of the color image data, which are next to each other on time base and an accelerator increasing a frame rate by which the color and gray image data are transmitted.

### CROSS-REFERENCE TO RELATED APPLICATION

This application claims the priority benefit of Japanese Patent Application No. 2007-085522, filed Mar. 28, 2007, the entire disclosure of which is incorporated herein by reference.

### BACKGROUND OF THE INVENTION

1. Field of the Invention

The invention relates to a liquid crystal display device, specifically for controlling a liquid crystal display panel, which displays color images.

2. Description of the Related Art

A general liquid crystal display device includes a plurality of pixels, each of which includes three sub-pixels having three primary colors, such as Red (R), Green (G) and Blue (B), respectively, in order to display all colors. The information as to the color to be displayed is transformed into a gradation signal of R, G and B in response to a luminance signal and a color-difference signal, and the gradation signal is then inputted to a timing controller. The gradation signal sent to the timing controller is sorted in order to display the image at a display panel, and the sorted gradation signal is sent to a driver, which is disposed on the display panel, for driving the display panel. The timing controller also generates other data necessary to display the image at the display panel.

According to the Japanese laid open patent publication JP 2006-317899A (Reference 1), a conventional liquid crystal display device, which can display color images naturally, is disclosed. The conventional liquid crystal display device disclosed in the reference includes a liquid crystal panel having 4-color sub-pixels, a data driver providing video data signals to each sub-pixel, a gate driver 106 providing a scan pulse to each sub-pixel, a data converter generating a gain value by analyzing a ratio of an achromatic color signal to a chromatic color signal of 3-color source data inputted from an external source and converting the 3-color source data into 4-color data using the generated gain value and a timing controller providing the 4-color data received from the data converter to the data driver and controlling the gate driver and the data driver.

Further, according to the Japanese laid open patent publication JP 2004-233932A (Reference 2), another conventional liquid crystal display device, which improves the quality of moving images (hereinafter it is called a “movie”) to be displayed at a liquid crystal display panel by writing an image signal and a black display signal to be displayed to the liquid crystal display panel in one frame cycle, is disclosed so that variation on the time base of screen luminance of the liquid crystal display panel is suppressed.

The numbers of colors that a liquid crystal display panel can display is determined by the gradation level at the sub-pixel for each of Red, Green and Blue. Namely, each sub-pixel being displayed with 6-bit data (hereinafter it is called “6-bit display panel”) creates the 64 gradation levels so that it is possible to display 64³ colors (=around 260,000 colors) because of the combination of Red, Green and Blue. If the sub-pixel is displayed with 8-bit data (hereinafter it is called “8-bit display panel”), which creates the 256 gradation levels, the display panel including such sub-pixels can display 256³ colors (=around 16,670,000 colors).

A display panel suitable for a TV displays the movies with 8-bit data so that the displayable color is 256³. In order to display the mover with deeper and finer colors, 10-bit data may be used so that the displayable color is 1,024³ colors (=around 10 billion colors). A display panel suitable for a digital cinema uses 12-bit data so that the displayable color is 4,096³ colors (=around 687 billion colors).

The following problems may occur when the bit numbers of each sub-pixel are increased.

(a) The output deviation of the driver is restricted.

Generally, the voltage to be applied to the display panel is 8V, for instance. When such a voltage per one gradation is divided linearly, 31.25 mV is applied in the case that each sub-pixel is displayed with 8-bit data (=256 gradation) and 7.80 mV is applied in the case that each sub-pixel is displayed with 10-bit data (=1024 gradation). Thus, circuits operable with high degree of accuracy are required.

(b) The huge scale of the decoder circuit (selector circuit) is required

When the 8-bit display panel is used, one gradation level can be selected from the 256 gradation levels. However, when the 10-bit display panel is used, one gradation level should be selected from the 1024 gradation levels, which is four times larger than that of the 8-bit display panel. Thus, the scale of the decoder circuit is also four times larger than that used for the 8-bit display panel.

As described above, although it is possible to increase the number of the displayable colors by increasing the bit numbers of each sub-pixel, the output deviation of the driver should be restricted, or the scale of the decoder circuit should be increased. For example, if the bit number is increased by two (2), the output deviation should be decreased by one-fourth (¼), and the scale of the decoder circuit becomes four times larger. In view of the accuracy and the manufacturing cost, a technical barrier for adopting such a technology described above would be high.

As described above, the technology disclosed in the Reference 1 relates to the display panel for displaying image naturally by increasing the number of the sub-pixels, and the technology disclosed in the Reference 2 relates to the display panel for improving the quality of a movie to be displayed at the liquid crystal display panel by writing an image signal and a black display signal to be displayed to the liquid crystal display panel in one frame cycle. Thus, the problems described above are not resolved by both of the References (1) and (2).

### SUMMARY OF THE INVENTION

An objective of the invention is to solve the above-described problem and to provide a liquid crystal display device, which can increase the number of the displayable colors without restricting the accuracy of the driver or without increasing the scale of the decoder circuit.

The objective is achieved by a liquid crystal display device including a liquid crystal display panel, a receiver, which receives color image data by frame in series, wherein the color image data are data of a color image being displayed on a liquid crystal display panel, a generator generating gray image data, which are data of a gray image displayable at the liquid crystal display panel, a selector inserting the gray image data as a frame image between two frames of the color image data, which are next to each other on time base and an accelerator increasing a frame rate by which the color and gray image data are transmitted.

### BRIEF DESCRIPTION OF THE DRAWINGS

The invention will be more particularly described with reference to the accompanying drawings, in which:

FIG. 1 is a block diagram of a liquid crystal display device, according to a preferred embodiment;

FIG. 2 is a block diagram of a timing controller used in the liquid crystal display device shown in FIG. 1;

FIG. 3 is a flow chart of processes performed in the timing controller shown in FIG. 2;

FIG. 4 is a conceptual diagram for explaining how a displayable color is increased; and

FIG. 5 is a graph showing VT characteristics of a liquid crystal display panel.

### DETAILED DESCRIPTION OF THE PREFERRED EMBODIMENTS

The preferred embodiment of the invention as to a liquid crystal display device is explained together with drawings as follows. In each drawing, the same reference numbers designate the same or similar components.

### The Preferred Embodiment

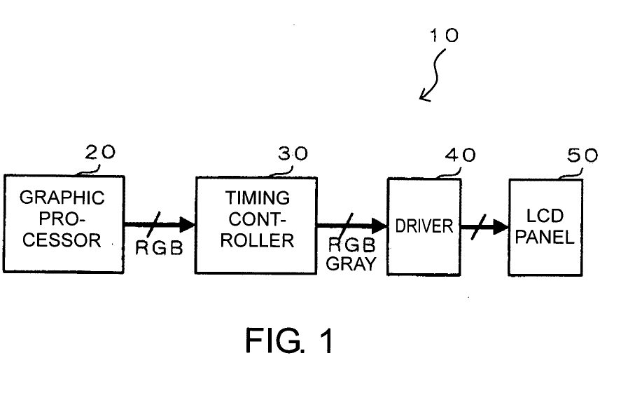

FIG. 1 is a block diagram of a liquid crystal display device 10, according to a preferred embodiment. As shown in FIG. 1, the liquid crystal display device 10 includes a liquid crystal display panel 50, which includes a plurality of pixels, for displaying color images. In the preferred embodiment, although the liquid crystal display panel 50 employs a TFT active matrix system, a STN passive matrix system or a DSTN passive matrix system may be employed.

The liquid crystal display device 10 further includes a graphic processor 20. The graphic processor 20 generates color image data, which indicates the color image to be displayed and are made up of pixel data of three prime colors (Red, Green and Blue) for each pixel. The graphic processor 20 of the preferred embodiment transmits the color image data in series by frame.

The liquid crystal display device 10 further includes a timing controller 30 having an input terminal, which is connected to the graphic processor 20 at its output terminal from which the color image data are transmitted. The timing controller 30 sorts the color image data transmitted from the graphic processor 20 in order to display the color image on the liquid crystal display panel 50 based on the color image data. The timing controller 30 includes a displayable color increasing function, which is performed by generating displayable gray image data, which indicates the gray image to be displayed, based on the information of the sorted color image data, and by inserting the displayable gray image data before or after the sorted color image data of each frame are transmitted so that the numbers of the color displayable at the display panel are increased. In the following detail explanation, although the timing controller 30 having the displayable color increasing function, which is performed by inserting the displayable gray image data after the sorted color image data of each frame are transmitted, is used, the timing controller 30 having the displayable color increasing function, which is performed by inserting the displayable gray image data before the sorted color image data of each frame are transmitted, may be used. The timing controller 30 also generates other data necessary to display the image at the display panel 50.

The liquid crystal display device 10 further includes a driver 40 having an input terminal, which is connected to the timing controller at its output terminal from which the sorted color image data in which the gray image data are inserted (hereinafter it is called “sorted image data having the gray image data”) are transmitted. The driver drives the display panel 50 in order to display the color image by using the sorted image data having the gray image data.

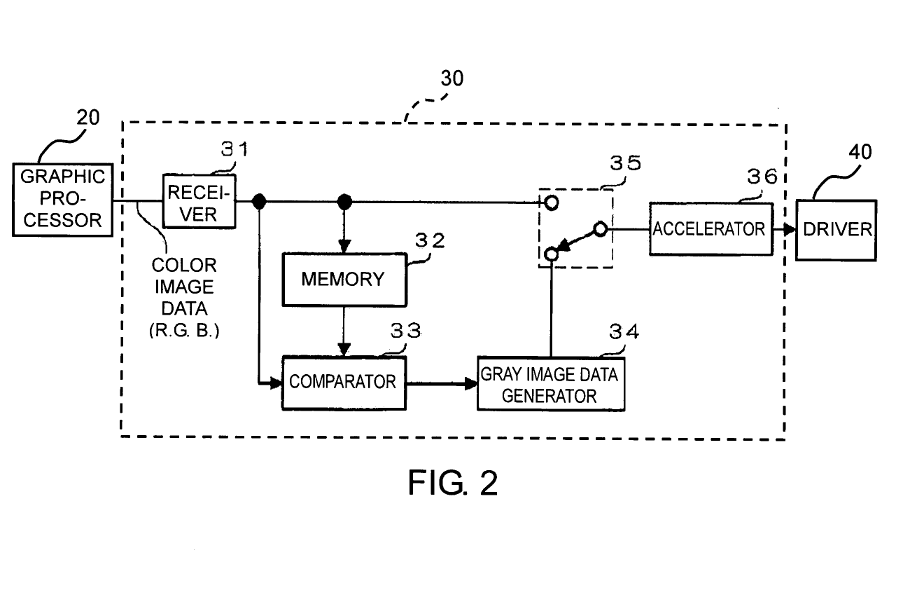

Next, the timing controller having the displayable color increasing function is explained below with reference to FIG. 2. FIG. 2 is a block diagram of a timing controller used in the liquid crystal display device shown in FIG. 1.

As shown in FIG. 2, the timing controller 30 includes a receiver 31, a memory 32, a comparator 33, a gray image data generator 34, a selector 35 and an accelerator 36.

The receiver 31 includes an input terminal, which is connected to the output terminal of the graphic processor 20 from which the color image data are transmitted. The receiver 31 boosts the color image data, which are transmitted in the LVDS (Low Voltage Differential Signaling) system, to the logical voltage level.

The memory 32 includes an input terminal, which is connected to the output terminal of the receiver 31 from which the boosted color image data are transmitted. The memory 32 stores the boosted color image data being transmitted from the graphic processor 20 via the receiver 31 for one frame, temporally and serially. Although a V-RAM (Video Random Access Memory) is used as the memory 32 in the preferred embodiment, another re-writable semiconductor memory may be used.

The comparator 33 includes two input terminals, one of which is connected to the output terminal of the receiver 31 from which the boosted image data are transmitted, and another of which is connected to the output terminal of the memory 32 from which the temporary stored color image data for one frame are transmitted. The comparator 33 compares the color image data stored in the memory 32 with the color image data of the next frame, which is transmitted next to the color image data stored in the memory 32. The comparison is made by frame in each pixel. In other words, luminance of each sub-pixels displaying Red, Green and Blue in a certain frame is compared with that of the corresponding sub-pixels displaying Red, Green and Blue in the next frame next. And then, the differences of the luminance between each sub-pixels displaying Red, Green or Blue of the two frames are measured. The average of the luminance of each sub-pixel for each of Red, Green and Blue is calculated from the measured differences. As a result of the comparison, the comparator 33 outputs the average information showing the average of the luminance of each sub-pixel for Red, Green and Blue.

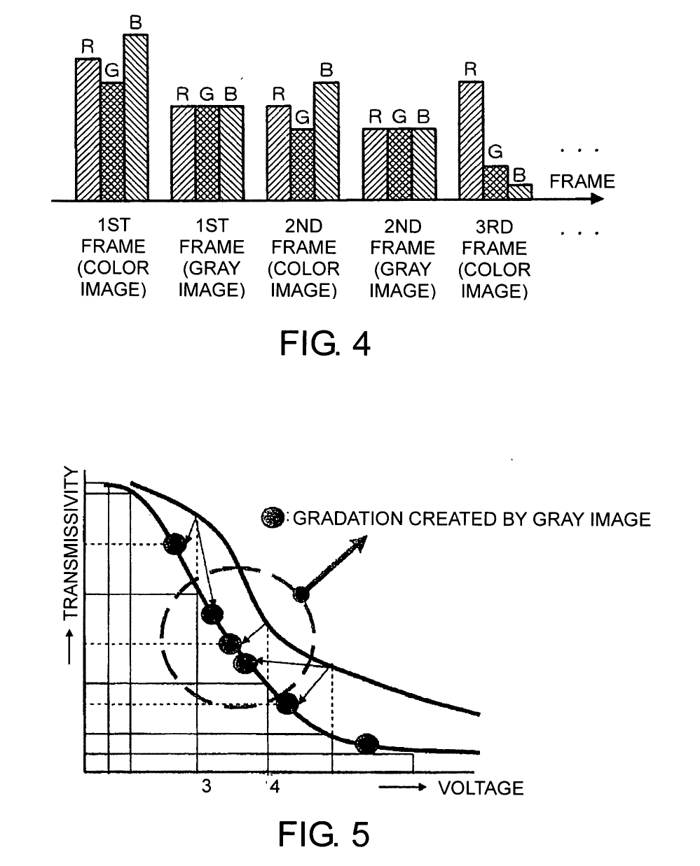

The gray image data generator 34 includes an input terminal, which is connected to the output terminal of the comparator 33 from which the average information is transmitted. Based on the average information sequentially transmitted from the comparator 33, the gray image data generator 34 generates gray image data having particular luminance corresponding to the average information. Here, the gray image data includes pixel data relating to luminance, each of which includes sub-pixel data relating to luminance corresponding to the sub-pixel data for Red, Green and Blue of the color image data, and thus, each sub-pixel data of the gray image data has its own luminance indicated by the average information. In other words, as shown in FIG. 4, which will be explained later, the luminance of the sub-pixel corresponding to Red, the luminance of the sub-pixel corresponding to Green, and the luminance of the sub-pixel corresponding to Blue in the gray image data become the same because of the application of the average information calculated in the comparator 33.

The selector 35 includes two input terminals, one of which is connected to the output terminal of the receiver 31 from which the boosted image data are transmitted, and another of which is connected to the output terminal of the gray image data generator 34 from which the gray image data are transmitted. The selector 35 outputs the color image data inputted from the graphic processor 20 via the receiver 31 and the gray image data inputted from gray image data generator 34 alternatively by one frame.

The accelerator 36 includes an input, which is connected to the output terminal of the selector 35, and an output terminal, which is connected to the input terminal of the driver 40 via an unillustrated transmitter, which will be explained later. The accelerator 36 increases at double the transmitting rate (frame rate) in which the color or gray image data are transmitted sequentially from the selector 35 to the driver 40.

The timing controller 30 may includes a serial/parallel converter, which generates the sorted color image data by sorting the boosted image data transmitted from the receiver 31 in order to display the image at the display panel 50, and the transmitter, which transforms the sorted color image data in which the gray image data is inserted, into the format such as RSDS (reduced Swing Differential Signaling) or mini-LVDS, which can be recognized by the driver 40, and then transmits the transformed data to the driver 40. The details of these components are omitted here.

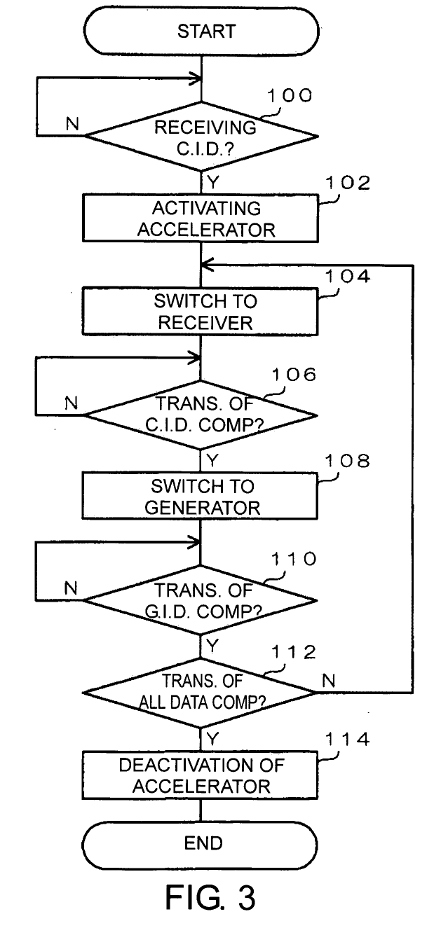

Next, the operation of the timing controller 30 for performing the displayable color increasing function is explained with reference to FIG. 3. In the following explanation, the operations of the transmitter or the serial/parallel converter are omitted because these operations do not directly relate to the displayable color increasing function. FIG. 3 is a flow chart of processes performed in the timing controller 30 shown in FIG. 2.

In the Step 100, the timing controller 30 waits for the color image data being transmitted from the graphic processor 20, at its receiver 31. In the Step 102, the accelerator 36 is instructed to be activated for its operation. In response to the instruction, the accelerator 36 is activated for its operation for increasing the transmitting rate at double.

After these steps, the color image data inputted from the graphic processor 20 sequentially are transmitted by one frame via the receiver 31 to the selector 35, to the memory 32 and to the comparator 33. Then, as described above, the comparator 33 compares the color image data stored in the memory 32 with the color image data of the next frame, which is transmitted next to the color image data stored in the memory 32, wherein the comparison is made in each pixel in frame. Then, the comparator 33 outputs the average information showing the average of the luminance of the sub-pixel for each of Red, Green and Blue to the gray image data generator 34, sequentially. Then, base on the average information sequentially transmitted from the comparator 33, the gray image data generator 34 generates the gray image data having particular luminance indicated by the average information, and outputs the gray image data to the selector 35.

In the Step 104, the selector 35 switches to its input terminal being connected to the receiver 31 for outputting the color image data to the accelerator 36. In the Step 106, it is confirmed that the transmission of the color image data for one frame is completed. In the Step 108, the selector 35 switches to its input terminal being connected to the gray image data generator 34 for outputting the gray image data to the accelerator 36. In the 110, it is confirmed that the transmission of the gray image data for one frame is completed.

In the Step 112, it is judged whether or not the process for receiving all color image data transmitted from the graphic processor 20 is completed. If the answer of the step 112 is “NO”, the Step 104 is repeated, and the answer of the step 112 is “YES”, the step 114 is performed. In the step 114, the accelerator 36 is instructed to be deactivated for its operation, and then the process is terminated.

The reason why the displayable color increasing function works by inserting the gray image data in the color image data is explained with reference to FIG. 4. FIG. 4 shows a conceptual diagram for explaining how a displayable color is increased. According to the process as described above, the color image data and the gray image data are alternatively and sequentially inputted to the driver 40, and the color image data and the gray image data are displayed at the display panel 50 at the double frame rate, sequentially. As a result, a viewer recognizes that the color image united with a monochrome image by the afterimage effect. This creates the effect same as increasing one sub-pixel.

This effect is supported by the result of the experimentation shown in FIG. 5. FIG. 5 is a graph showing the VT (Voltage-Transmissivity) characteristics of a liquid crystal display panel. In the graph, In FIG. 5, the voltage is measured along the horizontal axis and the transmissivity is measured along the vertical axis. As shown in FIG. 5, by inserting the gray image as one frame between the color images, it seems as if an intermediate transmissivity is applied by the one input-voltage as a discrete value, in addition to the transmissivity corresponding to the voltage being applied. As a result, it has the effect same as increasing one sub-pixel.

According to the liquid crystal display panel of the preferred embodiment, since the displayable gray image data are generated, and while such displayable gray image data are inserted as a frame image before or after each frame of the color image data, the frame rate is increased at double, the displayable color numbers are able to be increased without increasing the scale of the decoder circuit or without using the driver with high degree of accuracy.

Since the gray image data are generated from two frames of the color image data, which are next to each other on time base, the displayable color numbers are able to be increased accurately. Further, since the gray image data are generated in response to each pixel data of the color image data, the displayable color numbers are able to be increased accurately.

Moreover, since the gray image data are generated from the average information showing the average of the luminance, which is obtained from the luminance of the color image data of the two frames, which are next to each other on time base, the visual movie characteristics of the display panel can be further improved.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

For example, although increasing the displayable color numbers is performed by the hardware, it is possible to increase the displayable color number by software. In this case, the flowchart shown in FIG. 3 is performed by a computer with the computer readable program. When the processes shown in the flowchart of the FIG. 3 are performed by the software, the cost for manufacturing the device can be lowered.

Further, in the preferred embodiment, although the gray image data are inserted into the color image data, which are sorted by the unillustrated parallel/serial converter, it is possible to insert the gray image data into the color image data, which are not yet sorted by the unillustrated parallel/serial converter. The same benefit can be expected in both cases.

Moreover, in the preferred embodiment, although the gray image data are generated to have the luminance at its corresponding sub-pixel, which is the average of the luminance of each sub-pixel of the color image data of the two frames, which are next to each other on time base, the gray image data may be generated to have the other luminance if the color variations at the display panel are increased by such luminance. For example, when the gray image data having 3-bit gradation is used in addition to the color image data having 8-bit for each of Red, Green and Blue, 16,000,000 colors˜130,000,000 colors can be displayed.

Furthermore, in the preferred embodiment, although the gray image data are generated by each pixel of the color image data, the gray image data are generated by each frame of the color image data to have the same luminance as the whole frame image. Compared with the display panel in the preference embodiment, he visual movie characteristics (quality of moving images) of the display panel in the alternative can be further improved.

In the preferred embodiment, although increasing the displayable color numbers is performed in the timing controller 30, it can be performed in other components, such as the graphic processor 20 or the driver 40. The same benefit can be expected in any cases.

Various other modifications of the illustrated embodiment will be apparent to those skilled in the art on reference to this description. Therefore, the appended claims are intended to cover any such modifications or embodiments as fall within the true scope of the invention.

What I claim is:

1. A liquid crystal display device, comprising:
a liquid crystal display panel;
a receiver, which receives color image data by frame in series, wherein the color image data are data of a color image being displayed on a liquid crystal display panel;
a generator generating gray image data, which are data of a gray image displayable at the liquid crystal display panel; and
a selector inserting the gray image data as a frame image between two frames of the color image data, which are next to each other on time base; and
a accelerator increasing a frame rate by which the color and gray image data are transmitted.

2. A liquid crystal display device as claimed in claim 1, wherein the gray image data are generated by the two frames of the color image data, which are next to each other on time base.

3. A liquid crystal display device as claimed in claim 1, wherein the accelerator increases the frame rate at double.

4. A liquid crystal display device as claimed in claim 3, wherein the color image data includes at least a first color image data received at the receiver and a second color image data received at the receiver at the next to the first color image data, further comprising:
a memory temporary storing the first color image data including luminance information for one frame; and
a comparator comparing the luminance information of the first color image data with luminance information of the second color image data, and calculating average luminance between the first and the second color image data.

5. A liquid crystal display device as claimed in claim 4, wherein the gray image data includes the average luminance.

6. A liquid crystal display device as claimed in claim 4, wherein the luminance information is calculated from the luminance information of pixel data of each first and second color image data.

7. A liquid crystal display device as claimed in claim 1, wherein the gray image data include the same luminance for each sub-pixel in each pixel.

8. A liquid crystal display device as claimed in claim 1, wherein the gray image data include a plurality of gradation.
